(19) United States
(12) Patent Application Publication
(10) Pub. No.: US 2008/0196628 A1
(43) Pub. Date: Aug. 21, 2008

(54) Cement Compositions Comprising Rock-Forming Minerals and Associated Methods

(76) Inventors: Ashok Santra, Duncan, OK (US); Ronald Powell, Duncan, OK (US); Rickey Morgan, Duncan, OK (US)

Correspondence Address: CRAIG W. RODDY;HALLIBURTON ENERGY SERVICES, P.O. BOX 1431, DUNCAN, OK, 73536-0440, US

(21) Appl. No.: 11/676,659

(22) Filed: Feb. 20, 2007

(51) Int. Cl. C04B 7/00

(52) U.S. Cl. 106/705; 106/638; 106/808

(57) ABSTRACT

Of the many methods and compositions provided herein, one method includes placing a cement composition in a subterranean formation, wherein the cement composition includes cement, rock-forming mineral materials, and water; and permitting the cement composition to set therein. Another method provided herein includes introducing a settable drilling fluid into a subterranean formation, wherein the settable drilling fluid includes cement, rock-forming mineral materials, water, and a set retarder; and permitting the settable drilling fluid to set in therein. A composition provided herein includes cement, rock-forming mineral materials and water. Another composition provided herein includes cement, rock-forming mineral materials, water, and a set retarder.

### BACKGROUND OF THE INVENTION

The present invention relates to subterranean operations, and more particularly, to cement compositions comprising rock-forming mineral materials, and methods of using such cementing compositions in subterranean formations.

Hydraulic cement compositions are commonly utilized in subterranean operations, particularly subterranean well completion and remedial operations. For example, hydraulic cement compositions are used in primary cementing operations whereby pipe strings such as casings and liners are cemented in well bores. In performing primary cementing, hydraulic cement compositions are pumped into the annular space between the walls of a well bore and the exterior surface of the pipe string disposed therein. The cement composition is permitted to set in the annular space, thereby forming an annular sheath of hardened substantially impermeable cement therein that substantially supports and positions the pipe string in the well bore and bonds the exterior surface of the pipe string to the walls of the well bore. Hydraulic cement compositions also are used in remedial cementing operations such as plugging highly permeable zones or fractures in well bores, plugging cracks and holes in pipe strings, and the like.

Subterranean formations transversed by well bores are often weak, highly permeable, and extensively fractured. In some cases, such formations may be unable to withstand the hydrostatic head pressure normally associated with fluids (e.g., cement compositions and the like) being circulated in the well bore. In such cases, the hydrostatic pressure may be sufficient to force such fluids into the fractures and/or permeable zones of the formation, which may result in a significant loss of fluid into the formation. This loss of fluid circulation can be problematic for a number of reasons. For example, when the loss of circulation occurs during a cementing operation, excessive fluid loss may cause a cement composition to be prematurely dehydrated and may decrease the compressive strength of the cement composition. Excessive fluid loss into the formation may also prevent or reduce bond strength between the set cement composition and the subterranean zone, the walls of pipe, and/or the walls of the well bore.

Previous attempts to minimize the loss of circulation into the subterranean formation involved adding a variety of additives, including, but not limited to, asphaltenes, ground coal, cellulosic materials, plastic materials, walnut hulls, sized waste formica, and the like, to the cement composition. Such additives have been included, for example, to attempt to plug or bridge formation fractures and/or permeable zones in the formation where the treatment fluids typically may be lost. However, during a cementing operation, the addition of such conventional lost circulation materials often has proven to be detrimental to the compressive strength of the cement composition because, inter alia, it is believed that such additives do not bond to the cement. Because one function of the cement is to support the pipe string in the well bore, such reduction in the compressive strength of the cement composition is usually undesirable.

### SUMMARY OF THE INVENTION

The present invention relates to subterranean operations, and more particularly, to cement compositions comprising rock-forming mineral materials, and methods of using such cementing compositions in subterranean formations.

In one embodiment, the present invention provides a method comprising placing a cement composition in a subterranean formation; wherein the cement composition comprises cement, rock-forming mineral materials, and water; and wherein the rock-forming mineral materials comprise at least one of the following group: rhyolite, dacite, lactite, andesite, calcite, granite, basalt, dolomite, andesite, feldspars, amphiboles, pyroxenes, olivine, iron oxides, gabbro, syenite, diorite, dolerite, peridotite, trachyte, obsidian, quartz, derivatives thereof, and combinations thereof; and permitting the cement composition to set therein.

In another embodiment, the present invention provides a method comprising placing a cement composition in a subterranean formation; wherein the cement composition comprises cement, rock-forming mineral materials, and water, wherein the rock-forming mineral materials are present in the cement composition in an amount in the range of from about 40% to about 50% by weight of the cement, wherein the water is present in the cement composition in an amount in the range of from about 30% to about 180% by weight of the cement, and wherein the cement composition has a density in the range of from about 4 pounds per gallon to about 22 pounds per gallon; and permitting the cement composition to set therein.

In another embodiment, the present invention provides a cement composition comprising cement, water, and rock-forming mineral materials, wherein the rock-forming mineral materials comprise at least one of the following group: rhyolite, dacite, lactite, andesite, calcite, granite, basalt, dolomite, andesite, feldspars, amphiboles, pyroxenes, olivine, iron oxides, gabbro, syenite, diorite, dolerite, peridotite, trachyte, obsidian, and quartz.

In another embodiment, the present invention provides a method comprising introducing a settable drilling fluid into a subterranean formation; wherein the settable drilling fluid comprises cement, rock-forming mineral materials and water, and wherein the rock-forming mineral materials comprise at least one of the following group: rhyolite, dacite, lactite, andesite, calcite, granite, basalt, dolomite, andesite, feldspars, amphiboles, pyroxenes, olivine, iron oxides, gabbro, syenite, diorite, dolerite, peridotite, trachyte, obsidian, and quartz; and permitting the settable drilling fluid to set therein.

The features and advantages of the present invention will be readily apparent to those skilled in the art upon a reading of the description of the preferred embodiments which follows.

### DESCRIPTION OF PREFERRED EMBODIMENTS

The present invention relates to subterranean operations, and more particularly, to cement compositions comprising rock-forming mineral materials, and methods of using such cementing compositions in subterranean formations.

Although many advantages are presented by the present invention, one of the many advantages posed by the present invention exloits the ready availability of rock-forming mineral materials and the stability of rock-forming materials at high temperatures. Accordingly, the cement compositions of the present invention comprising rock-forming mineral materials may be particularly suitable for use in cementing operations wherein the bottom hole circulation temperature is below about 700° F. Other and further advantages and objects of the invention will be apparent to one of ordinary skill in the art with the benefit of this disclosure.

In some embodiments, the cement compositions of the present invention generally comprise cement, water, and rock-forming mineral materials, wherein the rock-forming mineral materials comprise at least one of the following group: rhyolite, dacite, lactite, andesite, calcite, granite, basalt, dolomite, andesite, feldspars, amphiboles, pyroxenes, olivine, iron oxides, gabbro, syenite, diorite, dolerite, peridotite, trachyte, obsidian, quartz, derivatives thereof, and combinations. Optionally, other additives suitable for use in conjunction with subterranean cementing operations may be added to these cement compositions if desired. Examples of such additives include, inter alia, fly ash, silica, fluid loss control additives, surfactants, dispersants, accelerators, salts, mica, fibers, formation-conditioning agents, bentonite, expanding additives, microspheres, weighting materials, defoamers, and combinations and derivatives thereof. One of ordinary skill in the art will recognize what additives may be appropriate to include for a given application.

Typically, the cement compositions of the present invention have a density in the range of from about 4 lb/gallon to about 22 lb/gallon. In certain exemplary embodiments, the cement compositions of the present invention have a density in the range of from about 8 lb/gallon to about 17 lb/gallon. One of ordinary skill in the art with the benefit of this disclosure will recognize the appropriate density of the cement composition for a chosen application.

The water utilized in the cement compositions of the present invention may be fresh water, salt water (e.g., water containing one or more salts dissolved therein), brine (e.g., saturated salt water), or seawater. Generally, the water may be from any source provided that it should not contain an excess of compounds, e.g., dissolved organics, that may adversely affect other components in the cement composition. The density of the water may vary based, inter alia, on the salt content. In certain exemplary embodiments, the water has a density in the range of from about 8.3 lb/gallon to about 9.5 lb/gallon. Further, the water may be present in an amount sufficient to form a pumpable slurry. In certain embodiments, the water is present in the cement compositions in an amount in the range of from about 30% to about 180% by weight of the cement (“bwoc”) therein. In certain embodiments, the water is present in the cement composition in the range of from about 40% to about 90% bwoc therein. In certain embodiments, the water is present in the cement composition in the range of from about 40% to about 60% bwoc therein. One of ordinary skill in the art with the benefit of this disclosure will recognize the appropriate amount of water for a chosen application.

Any cement suitable for use in subterranean applications is suitable for use in the present invention. In certain exemplary embodiments, the cement compositions of the present invention comprise a hydraulic cement. Suitable examples of hydraulic cements that may be used include, but are not limited to, those that comprise calcium, aluminum, silicon, oxygen, and/or sulfur, which set and harden by reaction with water. Examples include, but are not limited to, Portland cements, pozzolanic cements, gypsum cements, calcium phosphate cements, high alumina content cements, silica cements, high alkalinity cements, and mixtures thereof.

The cement compositions of the present invention further comprise rock forming mineral materials comprising at least one of the following group: rhyolite, dacite, lactite, andesite, calcite, granite, basalt, dolomite, andesite, feldspars, amphiboles, pyroxenes, olivine, iron oxides, gabbro, syenite, diorite, dolerite, peridotite, trachyte, obsidian, quartz, derivatives thereof, and combinations. In certain embodiments, the rock-forming mineral materials may comprise rhyolite. Rhyolite is an igneous, volcanic rock with silica (SiO₂) content that is usually greater than about 68 weight percent. The mineral assemblage of rhyolite is commonly quartz, feldspar, and biotite. In certain embodiments, the rock-forming mineral materials may comprise one or more of dacite, lactite, andesite, calcite, granite, basalt, dolomite, andesite, feldspars, amphiboles, pyroxenes, olivine, iron oxides, gabbro, syenite, diorite, dolerite, peridotite, trachyte, obsidian, and quartz. Other components also may be present. It is believed that the rock-forming mineral materials act, among other things, as a strength enhancing lost circulation material in the cement compositions of the present invention. Strength enhancing lost circulation materials are generally understood to be materials that provide a desired level of lost circulation control from the cement composition into the formation with minimal adverse impact to the compressive strength of the cement composition. Among other things, certain embodiments of the strength enhancing lost circulation material of the present invention bridge and/or plug fractures and permeable zones in the formation so as to minimize loss of fluid circulation into the formation. Generally, strength enhancing lost circulation materials chemically and/or mechanically bond to the matrix of the cement.

In certain embodiments of the present invention, the rock-forming mineral materials used in the cement compositions may have a density such that the rock-forming mineral materials do not rise to the surface of the well bore if circulation of the cement composition should cease.

Generally, the rock-forming mineral materials may have any particle size distribution that provides a desired level of lost circulation control. In certain embodiments, the rock-forming mineral materials may have a particle size distribution in the range of from about 30 micrometers to about 5000 micrometers. In certain embodiments, the rock-forming mineral materials may have a particle size distribution in the range of from about 70 micrometers to about 4750 micrometers. An example of a suitable rock-forming mineral material is “Headlap Granules,” which is commercially available from McCabe Industrial Mineral Company, Tulsa, Okla.

Generally, the rock-forming mineral materials may be present in the cement compositions in an amount sufficient to provide a desired level of lost circulation control. In one embodiment, the rock-forming mineral materials may be present in the cement composition in an amount in the range of from about 0.5% to about 50% bwoc. In certain exemplary embodiments, the rock-forming mineral materials may be present in the cement composition in an amount in the range of from about 5% to about 10% bwoc. One of ordinary skill in the art with the benefit of this disclosure will recognize the appropriate amount of the rock-forming mineral materials for a chosen application.

Optionally, the cement composition may further comprise a second lost circulation material. The second lost circulation material may be any material that minimizes the loss of fluid circulation into the fractures and/or permeable zones of the formation. Suitable second lost circulation materials typically comprise a variety of materials, which include, but are not limited to, asphaltines, ground coal, cellulosic, plastic materials, and the like. The second lost circulation materials may be provided in particulate form. One of ordinary skill in the art with the benefit of this disclosure will recognize the appropriate amount of the second lost circulation material for a chosen application.

Optionally, in some embodiments, the cement compositions of the present invention further may comprise a set retarder. As used herein, the term “set retarder” refers to an additive that extends the time during which a cement composition remains pumpable after it is mixed into a slurry. If a set retarder is included, the cement compositions of the present invention also may be used as settable drilling fluids. Generally, a settable drilling fluid is a fluid utilized during drilling operations that will set over time and develop a compressive strength. Also referred to as settable spotting fluids, settable drilling fluids may be used so that if any of the settable drilling fluid remains in the well bore during primary cementing, the settable drilling fluid will set and act as a part of the hardened cement matrix. Settable spotting fluids and their utility are further described in U.S. Pat. No. 7,150,321, the relevant portions of which are herein incorporated by reference.

The settable drilling fluids of the present invention may be formulated so that they are compatible with drilling fluid, if any, that remains in a well bore from drilling operations previously performed in the well bore. When used as a settable drilling fluid, the cement compositions of the present invention may be introduced to the well bore during drilling operations and allowed to set in the well bore after drilling operations are complete. Thus, according to one embodiment, a settable drilling fluid comprising cement, rhyolite materials, water and at least one set retarder is introduced into a well bore. Portions of the settable drilling fluid remain on the walls of the well bore as part of the filter cake, and/or in permeable areas affecting the well bore, even if washes or spacer fluids are introduced into the well bore subsequent to the settable spotting fluid. The cement in the settable drilling fluid in the remaining portions naturally begins to set, while the retarder slows the set so that it occurs over a desired period of time. According to such an embodiment, other drilling operations can proceed, which operations may require other muds, fluids, or compositions to be subsequently pumped into the well bore.

Selection of the type and amount of set retarder(s) largely depends on the exact composition of the settable drilling fluid, and it is within the means of those of ordinary skill in the art to select a suitable type and amount of set retarder. Examples of suitable set retarders include, but are not limited to, ammonium, alkali metals, alkaline earth metals, metal salts of sulfoalkylated lignins, hydroxycarboxy acids, copolymers of 2-acrylamido-2-methylpropane sulfonic acid salt and acrylic acid or maleic acid, and combinations thereof. One example of a suitable sulfoalkylate lignin comprises a sulfomethylated lignin. Other examples and characteristics of suitable set retarding additives are disclosed in more detail in U.S. Pat. No. Re. 31,190, the entire disclosure of which is incorporated herein by reference. Example set retarding additives are commercially available from Halliburton Energy Services, Inc. under the tradenames HR® 4, HR® 5, HR® 7, HR® 12, HR® 15, HR® 25, SCR™ 100, and SCR™ 500.

Generally, where used, the set retarding additive may be included in the cement compositions of the present invention in an amount sufficient to provide the desired set retardation. Moreover, it is within the means of those of ordinary skill in the art to exert control over the amount of time that it takes the settable drilling fluid to set by determining, through the exercise of routine experimentation, the amount of set retarder necessary to achieve a set over a desired period of time. In some embodiments, the set retarding additive may be present in an amount in the range of from about 0.01% to about 20% by weight of the cement composition. In some embodiments, the set retarding additive may be present in an amount in the range of from about 0.05% to about 10% by weight of the cement composition.

Additional additives may be added to the cement compositions of the present invention as deemed appropriate by one skilled in the art with the benefit of this disclosure. Examples of such additives include, inter alia, fly ash, silica, fluid loss control additives, surfactants, dispersants, accelerators, salts, mica, fibers, formation-conditioning agents, bentonite, expanding additives, microspheres, weighting materials, defoamers, and combinations and derivatives thereof. For example, the cement compositions of the present invention may be foamed cement compositions comprising one or more foaming surfactants that may generate foam when contacted with a gas, e.g., nitrogen. An example of a suitable fly ash is an ASTM class F fly ash that is commercially available from Halliburton Energy Services of Dallas, Tex. under the trade designation “POZMIX® A.” An example of a suitable expanding additive comprises deadburned magnesium oxide and is commercially available under the trade name “MICROBOND HT” from Halliburton Energy Services, Inc., at various locations.

An embodiment of a cement composition of the present invention comprises cement, rock-forming mineral materials, and water. An embodiment of a cement composition of the present invention comprises Texas Lehigh Premium cement, 5% rock-forming mineral bwoc, and 39.4% water bwoc. Another embodiment of a cement composition of the present invention comprises Texas Lehigh Premium cement, 10% rock-forming mineral bwoc, and 39.4% water bwoc.

An embodiment of a method of the present invention comprises placing a cement composition into a subterranean formation, wherein the cement composition comprises cement, rock-forming mineral materials, and water sufficient to form a pumpable slurry; and permitting the cement composition to set therein. In certain embodiments, the step of introducing a cement composition into a subterranean formation may mean that a cement composition is introduced into a well bore. Another embodiment of a method of the present invention comprises introducing a settable drilling fluid into a subterranean formation, wherein the settable drilling fluid comprises cement, rock forming mineral materials, water, and a set retarder; and permitting the settable drilling fluid to set therein. In certain embodiments, the step of introducing a settable drilling fluid into a subterranean formation may mean that a settable drilling fluid is introduced into a well bore.

To facilitate a better understanding of the present invention, the following examples of some of the preferred embodiments are given. In no way should such examples be read to limit the scope of the invention.

### EXAMPLE 1

Rhyolite samples commercially available as “Headlap granules” from McCabe Industrial Mineral Company, Tulsa, Okla., are designated here as Rhyolite Sample No. 1. Rhyolite Sample No. 2 was derived from Rhyolite Sample No. 1 by adding a percentage of the large size particulates (thru 4 on 8). The results of a sieve analysis of the samples are depicted in Table 1.

TABLE 1

| | Rhyolite Sample | Rhyolite Sample |
|---|---|---|
| Size | No. 1 (%) | No. 2 (%) |
| On 4 | 0 | 0 |
| Thru 4 on 8 | 0.5 | 4.8 |
| Thru 8 on 20 | 57.3 | 54.8 |
| Thru 20 on 40 | 40.19 | 38.4 |
| Thru 40 on 60 | 0.91 | 0.9 |
| Thru 60 on 100 | 0.25 | 0.25 |
| Thru 100 on 140 | 0.15 | 0.15 |
| Thru 140 on 200 | 0.1 | 0.1 |
| Thru 200 on 325 | 0.1 | 0.1 |
| Thru 325 on Pan | 0.5 | 0.5 |

### EXAMPLE 2

Sample cement compositions were prepared by mixing a base cement slurry with a lost circulation material in accordance with the following procedure. The base cement slurry was prepared by mixing Joppa Class H cement (LaFarge, USA) with 38% water bwoc. Each sample cement composition was then prepared by mixing the base cement slurry with 5% of the lost circulation material bwoc at 12000-15000 rpm in a Waring blender for approximately 35 seconds. After sample preparation, a performance comparison test was conducted with different slot sizes and differential pressures in accordance with the standard API recommended practice 10B (22nd edition, December 1997).

Sample Cement Composition No. 1 was prepared by mixing the base cement slurry with 5% Rhyolite Sample No. 1.

Sample Cement Composition No. 2 was prepared by mixing the base cement slurry with 5% Rhyolite Sample No. 2.

Sample Cement Composition No. 3 was prepared by mixing the base cement slurry with 5% Phenoseal (available from Halliburton Energy Services).

A summary of the performance demonstrated by each sample cement composition is depicted in Table 2 below.

TABLE 2

| Sample Cement | | Time to plug with | Time to plug with |
|---|---|---|---|
| Composition No. | Slot size (mm) | no psi (sec) | 100 psi (sec) |
| 1 | 2 | 10 | 3 |
| 2 | 4 | 351 | 2 |
| 3 | 3 | 60 | 10 |

Thus, the above example demonstrates, inter alia, that the cement compositions of the present invention comprising rock-forming mineral materials are capable of plugging relatively large slots with an acceptable time frame relative to other cement compositions.

### EXAMPLE 3

Sample cement compositions were prepared by mixing a base cement slurry with a lost circulation material in accordance with the following procedure. The base cement slurry was prepared by mixing Joppa Class H cement (LaFarge, USA) with 38% water bwoc. Each sample cement composition was then prepared by mixing the base cement slurry with a specified amount of lost circulation material at 12000-15000 rpm in a Waring blender for approximately 35 seconds. After sample preparation, a compressive strength development was tested using Ultrasonic Cement Analyzer (UCA) (Fann Instruments, Houston, Tex.) at specified temperatures and times. Also cured samples (cylinders) were crush tested using a Tinius Olsen tester (model 398) immediately after removal from the UCA.

Sample Cement Composition No. 4 consisted of the base cement slurry. No lost circulation material was included.

Sample Cement Composition No. 5 was prepared by mixing the base cement slurry with 5% Rhyolite Sample No. 2 bwoc.

Sample Cement Composition No. 6 was prepared by mixing the base cement slurry with 10% Rhyolite Sample No. 2 bwoc.

Sample Cement Composition No. 7 was prepared by mixing the base cement slurry with 10% Gilsonite (Halliburton Energy Services, Inc., at various locations) bwoc.

Sample Cement Composition No. 8 was prepared by mixing the base cement slurry with 10% Phenoseal (Halliburton Energy Services, Inc., at various locations) bwoc.

A summary of the compressive strength and crush strength demonstrated by each sample cement composition is depicted in Table 3 below.

TABLE 3

| Sample Cement | | | 500 psi | 23.5 hr | 23.5 hr |
|---|---|---|---|---|---|
| Composition | Temperature | 50 psi Time | Time | Strength | Crush |
| No. | (° F.) | (hr:min) | (hr:min) | (psi) | (psi) |
| 4 | 80 | 6:10 | 12:00 | 2250 | 1806 |
| | | | | (47 hr) | (47 hr) |
| 4 | 200 | 1:50 | 2:15 | 3220 | 3600 |
| 5 | 200 | 1:50 | 2:28 | 3300 | 4080 |
| 6 | 80 | 6:10 | 12:20 | 2600 | 2460 |
| | | | | (47 hr) | (47 hr) |
| 6 | 200 | 1:38 | 2:05 | 3600 | 5900 |
| 7 | 200 | 2:00 | 2:44 | 2200 | 2330 |
| 8 | 200 | 4:02 | 5:31 | 2820 | 3020 |

Thus, the above example demonstrates, inter alia, that the cement compositions of the present invention comprising rock-forming mineral materials provide enhanced compressive strength relative to other cement compositions.

### EXAMPLE 4

Sample cement compositions were prepared by mixing a base cement slurry with a lost circulation material in accordance with the following procedure. The base cement slurry used in Sample Cement Composition Nos. 9, 10, 11, and 12 was at 16.4 pounds per gallon (ppg) and prepared with Joppa Class H cement (LaFarge, USA) and water. The base cement slurry used in Sample Cement Composition Nos. 13 and 14 was at 16.3 ppg and prepared with Joppa Class H cement (LaFarge, USA), 35% SSA-2 bwoc, 0.3% HALAD®-413 bwoc, 0.7% HALAD®-344 bwoc, and water. SSA-2™ is a course silica flour, HALAD®-413 and HALAD®-344 are fluid loss control additives, all commercially available from Halliburton Energy Services, Inc., at various locations. Some Sample Cement Compositions also comprised set retarder, HR®-5, HR®-25, and/or SCR-100™, all commercially available from Halliburton Energy Services, Inc. at various locations. Each sample cement composition was then prepared by mixing the base cement slurry with a specified amount of lost circulation material at 12000-15000 rpm in a Waring blender for approximately 35 seconds. Testing was performed in accordance with API Recommended Practice 10 B, effective date Oct. 1, 2002.

Sample Cement Composition No. 9 consisted of the base cement slurry comprising 39.42% water bwoc. No lost circulation material was included. Testing temperature was 120° F.

Sample Cement Composition No. 10 was prepared by mixing the base cement slurry (comprising 40.93% water bwoc) with 5 pounds per sack (#/sk) Rhyolite Sample No. 2. Testing temperature was 120° F.

Sample Cement Composition No. 11 consisted of the base cement slurry comprising 39.3% water bwoc and 0.3% HR®-5 bwoc. No lost circulation material was included. Testing temperature was 205° F.

Sample Cement Composition No. 12 was prepared by mixing the base cement slurry (comprising 40.81% water bwoc) with 5 #/sk Rhyolite Sample No. 2 and 0.3% HR®-5 bwoc. Testing temperature was 205° F.

Sample Cement Composition No. 13 consisted of the base cement slurry comprising 48.91% water bwoc, 0.3% HR®-25 bwoc, and 0.6% SCR-100 bwoc. No lost circulation material was included. Testing temperature was 285° F.

Sample Cement Composition No. 14 was prepared by mixing the base cement slurry (comprising 51.39% water bwoc) with 5 #/sk Rhyolite Sample No. 2, 0.3% HR®-25 bwoc, and 0.6% SCR-100 bwoc. Testing temperature was 285° F.

The effects of rhyolite on thickening time was investigated and the results summarized in Table 4 below.

TABLE 4

| Sample | | | | | | |
|---|---|---|---|---|---|---|
| Cement | Pump | Time to | Time to | 24 hr | Final | Crush* |
| Composition | Time | 50 psi | 500 psi | Strength | Strength | Strength |
| No. | (hr:min) | (hr:min) | (hr:min) | (psi) | (psi) | (psi) |
| 9 | 5:01 | 3:40 | 6:33 | 1978 | 3050 | N/A |
| | | | | | @ 66 hrs | |
| 10 | 5:08 | 3:20 | 6:38 | 1908 | 3100 | N/A |
| | | | | | @ 66 hrs | |
| 11 | 2:40 | 3:40 | 4:40 | 3047 | 3300 | 5260 |
| | | | | | @ 46 hrs | |
| 12 | 3:15 | 3:30 | 4:31 | 2958 | 3179 | 5660 |
| | | | | | @ 46 hrs | |
| 13 | 6:12 | 15:03 | 16:36 | 872 | 861 | 1531 |
| | | | | | @ 47 hrs | |
| 14 | 5:55 | 14:46 | 16:02 | 1162 | 1186 | 1823 |
| | | | | | @ 47 hrs | |

*Crush test was carried out immediately after taking the final strength reading in UCA.

Thus, the above example demonstrates, inter alia, that the cement compositions of the present invention comprising rock-forming mineral materials show no significant adverse effects upon thickening time at least up to a temperature of 285° F. when compared to other cement compositions.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. In particular, every range of values (of the form, “from about a to about b,” or, equivalently, “from approximately a to b,” or, equivalently, “from approximately a-b”) disclosed herein is to be understood as referring to the power set (the set of all subsets) of the respective range of values, and set forth every range encompassed within the broader range of values. Also, the terms in the claims have their plain, ordinary meaning unless otherwise explicitly and clearly defined by the patentee.

What is claimed is:

1. A method comprising:
placing a cement composition in a subterranean formation; wherein:
the cement composition comprises cement, rock-forming mineral materials, and water; and
the rock-forming mineral materials comprise at least one of the following group: rhyolite, dacite, lactite, andesite, calcite, granite, basalt, dolomite, andesite, feldspars, amphiboles, pyroxenes, olivine, iron oxides, gabbro, syenite, diorite, dolerite, peridotite, trachyte, obsidian, quartz, derivatives thereof, and combinations thereof; and
permitting the cement composition to set therein.

2. The method of claim 1 wherein the cement composition further comprises at least one of the following group: fly ash, silica, fluid loss control additives, surfactants, dispersants, accelerators, salts, mica, fibers, formation-conditioning agents, bentonite, expanding additives, microspheres, weighting materials, defoamers, and combinations and derivatives thereof.

3. The method of claim 1 wherein the cement composition further comprises a set retarder.

4. The method of claim 3 wherein the set retarder comprises at least one of the following group: ammonium, alkali metals, alkaline earth metals, metal salts of sulfoalkylated lignins, hydroxycarboxy acids, copolymers of 2-acrylamido-2-methylpropane sulfonic acid salt and acrylic acid or maleic acid, and combinations thereof.

5. The method of claim 1 wherein the cement composition has a density in the range of from about 4 pounds per gallon to about 22 pounds per gallon.

6. The method of claim 1 wherein the water is present in the cement composition in an amount sufficient to form a pumpable slurry.

7. The method of claim 1 wherein the cement comprises a hydraulic cement.

8. The method of claim 1 wherein the rock-forming mineral materials have a particle size distribution in the range of from about 30 micrometers to about 5000 micrometers.

9. The method of claim 1 wherein the rock-forming mineral materials are present in the cement composition in an amount in the range of from about 0.5% to about 50% by weight of the cement.

10. The method of claim 1 wherein the cement composition further comprises a second lost circulation material.

11. A method comprising:
placing a cement composition in a subterranean formation; wherein:
the cement composition comprises cement, rock-forming mineral materials, and water;
the rock-forming mineral materials are present in the cement composition in an amount in the range of from about 40% to about 50% by weight of the cement;
water is present in the cement composition in an amount in the range of from about 30% to about 180% by weight of the cement; and
the cement composition has a density in the range of from about 4 pounds per gallon to about 22 pounds per gallon; and
permitting the cement composition to set therein.

12. The method of claim 11 wherein at least a portion of the rock-forming mineral materials are selected from the group consisting of rhyolite, dacite, lactite, andesite, calcite, granite, basalt, dolomite, andesite, feldspars, amphiboles, pyroxenes, olivine, iron oxides, gabbro, syenite, diorite, dolerite, peridotite, trachyte, obsidian, and quartz.

13. A cement composition comprising:
cement;
water; and
rock-forming mineral materials, wherein the rock-forming mineral materials comprise at least one of the following group: rhyolite, dacite, lactite, andesite, calcite, granite, basalt, dolomite, andesite, feldspars, amphiboles, pyroxenes, olivine, iron oxides, gabbro, syenite, diorite, dolerite, peridotite, trachyte, obsidian, quartz, derivatives thereof, and combinations thereof.

14. The composition of claim 13 wherein:
the rock-forming mineral materials are present in the cement composition in an amount in the range of from about 40% to about 50% by weight of the cement;
water is present in the cement composition in an amount in the range of from about 30% to about 180% by weight of the cement; and
the cement composition has a density in the range of from about 4 pounds per gallon to about 22 pounds per gallon.

15. A method comprising:
introducing a settable drilling fluid into a subterranean formation; wherein:
the settable drilling fluid comprises cement, rock-forming mineral materials and water; and
the rock-forming mineral materials comprise at least one of the following group: rhyolite, dacite, lactite, andesite, calcite, granite, basalt, dolomite, andesite, feldspars, amphiboles, pyroxenes, olivine, iron oxides, gabbro, syenite, diorite, dolerite, peridotite, trachyte, obsidian, quartz, derivatives thereof, and combinations thereof; and
permitting the settable drilling fluid to set in therein.

16. The method of claim 15 wherein the settable drilling fluid further comprises at least one of the following group: fly ash, silica, fluid loss control additives, surfactants, dispersants, accelerators, salts, mica, fibers, formation-conditioning agents, bentonite, expanding additives, microspheres, weighting materials, defoamers, and combinations and derivatives thereof.

17. The method of claim 15 wherein the settable drilling fluid has a density in the range of from about 4 pounds per gallon to about 22 pounds per gallon.

18. The method of claim 15 wherein the water is present in the settable drilling fluid in an amount sufficient to form a pumpable slurry.

19. The method of claim 15 wherein the cement comprises a hydraulic cement.

20. The method of claim 15 wherein the rock-forming mineral materials have a particle size distribution in the range of from about 30 micrometers to about 5000 micrometers.

21. The method of claim 15 wherein the rock-forming mineral materials are present in the settable drilling fluid in an amount in the range of from about 0.5% to about 50% by weight of the cement.

22. The method of claim 15 wherein the settable drilling fluid further comprises a second lost circulation material.

23. The method of claim 15 wherein the set retarder comprises at least one of the following group: ammonium, alkali metals, alkaline earth metals, metal salts of sulfoalkylated lignins, hydroxycarboxy acids, copolymers of 2-acrylamido-2-methylpropane sulfonic acid salt and acrylic acid or maleic acid, and combinations thereof.
